(19) United States
(12) Patent Application Publication
(10) Pub. No.: US 2021/0185147 A1
(43) Pub. Date: Jun. 17, 2021

(54) INFORMATION PROCESSING APPARATUS, CONTROL APPARATUS, MIGRATION METHOD AND PROGRAM

(71) Applicant: Nippon Telegraph and Telephone Corporation, Tokyo (JP)

(72) Inventors: Koji Sugisono, Tokyo (JP); Hirofumi Yamazaki, Tokyo (JP)

(21) Appl. No.: 17/052,600

(22) PCT Filed: May 13, 2019
(86) PCT No.: PCT/JP2019/018868

§ 371 Date: Nov. 3, 2020

(30) Foreign Application Priority Data
May 24, 2018 (JP) 2018-099560

(51) Int. Cl. H04L 29/08; H04L 12/741; H04L 12/725

(52) U.S. Cl. CPC H04L 67/34; H04L 45/306; H04L 45/74

(57) ABSTRACT

An information processing device includes a control unit configured to control a transfer of software performing processing of a packet to or from another computer, and an attachment unit configured to attach, to a packet output from the software of a transfer source or a transfer destination, a transmission source address different from the transfer destination or the transfer source, thereby avoiding the occurrence of communication error when software relevant to packet processing is transferred to another computer.

### TECHNICAL FIELD

The present invention relates to an information processing device, a control device, a transfer method, and a program

### BACKGROUND ART

In the related art, virtual machine technology that realizes, by software, an operating environment of applications realized using a physical server has been developed. A virtual machine is software, and is operated on a physical platform having an environment in which the virtual machine is operated. When there are a plurality of servers with an operating environment, it is possible to move a virtual machine onto another server in a state in which the virtual machine is operating, and continuously operate the virtual machine. This operation is referred to as live migration and is used as a system for continuing a service at the time of failure or maintenance of the server.

With the development of Virtual machine technology, attention has been paid to network functions virtualization (NFV) technology for performing packet processing using a virtual machine. In NFV technology, packet processing is performed in software. The software that performs packet processing is referred to as a Virtualized Network Function (VNF).

The VNF updates a large number of pieces of data which are used for packet processing. Thus, when the VNF is migrated, the data at the transfer source and the transfer destination are required to be synchronized. The amount of data to be synchronized in this case is larger than when the virtual machine is used for other applications. Thus, when the traffic is large, data to be synchronized may be updated in a VNF of the transfer source during migration and the time required for migration may be prolonged due to synchronization of the updated portion. Thus, it may take tame to complete the migration.

In order to solve this problem, a method is proposed for synchronizing VNFs on a server that is a transfer source and a server that is a transfer destination and operating the same VNF on both of the servers for a while after the synchronization is complete to thereby continue packet processing, when the VNF is transferred to another server (Non-Patent Literature 1).

### CITATION LIST

### Non Patent Literature

Non-Patent Literature 1: Sugisono et al., “Proposal of live migration scheme suitable for virtualized network function”, Institute of Electronics, Information and Communication Engineers, Society Conference, 2017, Autumn

### SUMMARY OF THE INVENTION

### Technical Problem

In a scheme of Non Patent Literature 1, path information of a Layer 2 switch is updated after the synchronization of the VNF is completed. This is for changing a transfer destination of a data packet to be processed by the VNF from a server before transfer to a server that is a transfer destination.

A procedure for updating the path information is as follows.

(1) First, a VNF that is a transfer destination transmits a broadcast packet in which a Layer 2 address thereof is attached to a transmission source address field.
(2) A Layer 2 switch in a network collates a transmission source address field of the arriving broadcast packet with a packet arrival port and sets an output destination of a packet addressed to the transfer destination VNF.
(3) After the output destination of the packet addressed to the transfer destination VNF is set, the Layer 2 switch transfers the data packet to the VNF that is operating on the server that is transfer destination.

A path information updating mechanism of Ethernet (registered trademark) has a problem in that it takes time for all switches to update path information and output packets correctly. In the scheme of Non-Patent Literature 1, the VNF is operated on the server that is a transfer source after the synchronization is complete and the VNF processes data packets that have reached the server that is a transfer source. An address of the VNF is attached to a transmission source address of the data packet processed by the VNF which is a transfer source. In this case, addresses indicating packet transmission sources attached to the broadcast packet transmitted by the VNF that is a transfer destination and the data packet transmitted by the VNF that is a transfer source are the same (that is, the address of the transfer source overlaps the address of the transfer destination).

Because the data packet transmitted by the VNF that is a transfer source also triggers processing of updating a path of the Layer 2 switch, the path information updated by the broadcast packet transmitted by the transfer destination VNF is re-updated by the data packet transmitted by the transfer source VNF. As a result, the data packet reaches the transfer source again and the data packet does not reach the transfer destination.

The present invention is made in view of the above points, and an object of the present invention is to avoid the occurrence of communication error when software relevant to packet processing is transferred to another computer.

### Means for Solving the Problem

In order to solve the above problem, an information processing device includes a control unit configured to control a transfer of software performing processing of a packet to or from another computer; and an attachment unit configured to attach, to a packet output from the software of a transfer source or a transfer destination, a transmission source address different from the transfer destination or the transfer source.

### Effects of the Invention

It is possible to avoid the occurrence of communication error when software relevant to packet processing is transferred to another computer.

### BRIEF DESCRIPTION OF DRAWINGS

FIG. 1 is a diagram illustrating an example of a configuration of a data transfer system 1 according to a first embodiment.

FIG. 2 is a diagram illustrating an example of a hardware configuration of a server 10 in the first embodiment.

FIG. 3 is a diagram illustrating an example of a functional configuration of the server 10 and a controller 20 in the first embodiment.

FIG. 4 is a sequence diagram illustrating an example of a processing procedure regarding migration of a VNF in the first embodiment.

FIG. 5 is a sequence diagram illustrating an example of a processing procedure regarding migration of a VNF in a second embodiment.

### DESCRIPTION OF EMBODIMENTS

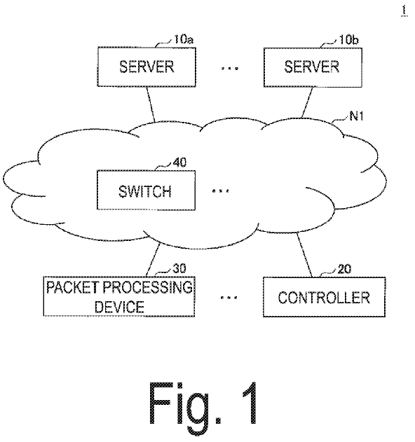

Hereinafter, embodiments of the present invention will be described with reference to the drawings. FIG. 1 is a diagram illustrating one example of a configuration of a data transfer system 1 according to a first embodiment. In the data transfer system 1 illustrated in FIG. 1, a plurality of servers 10, such as a server 10a and a server 10b, a controller 20, and one or more packet processing devices 30 are connected via a network N1. The network N1 is a network of Layer 2 (that is, Local Area Network (LAN)) including one or more switches 40.

The server 10 is a computer on which a virtual machine operates. In the embodiment, processing of software that realizes a virtualized network function (VNF) on the virtual machine (hereinafter simply referred to as a “VNF process”) is operated on the server 10.

The controller 20 is a computer that instructs the server 10 to perform migration (live migration) of the VNF or provides various notifications associated with the migration to the packet processing device 30 or the like. Correspondence information between the VNF and the packet processing device 30 that performs packet processing regarding the VNF, for example, is stored in the controller 20.

The packet processing device 30 acquires information such as an address from a header of a packet, and performs processing on the packet on the basis of the address. For example, a device that performs Network Address and Port Translation (NAPT), a device that functions as a firewall, a software defined network (SDN) switch, or the like may be the packet processing device 30. In the embodiment, the “packet” means a packet (frame) of Layer 2 unless otherwise specified. Further, the “address” means an address (a MAC address) of Layer 2 unless otherwise specified.

FIG. 2 is a diagram illustrating an example of a hardware configuration of the server 10 in the first embodiment. The server 10 in FIG. 2 includes a drive device 100, an auxiliary storage device 102, a memory device 103, a CPU 104, an interface device 105, and the like that are connected to each other via a bus B.

A program for realizing processing on the server 10 is provided by a recording medium 101 such as a CD-ROM. When the recording medium 101 storing the program is set in the drive device 100, the program is installed in the auxiliary storage device 102 from the recording medium 101 via the drive device 100. However, the program is not necessarily installed from the recording medium 101 and may be downloaded from another computer via a network. The auxiliary storage device 102 stores the installed program and also stores required files, data, and the like.

The memory device 103 reads and stores the program from the auxiliary storage device 102 when an instruction to activate the program is provided. The CPU 104 executes functions relevant to the server 10 according to the program stored in the memory device 103. The interface device 105 is used as an interface for connection to a network.

The controller 20, the packet processing device 30, the switch 40, and the like may also have the hardware illustrated in FIG. 2.

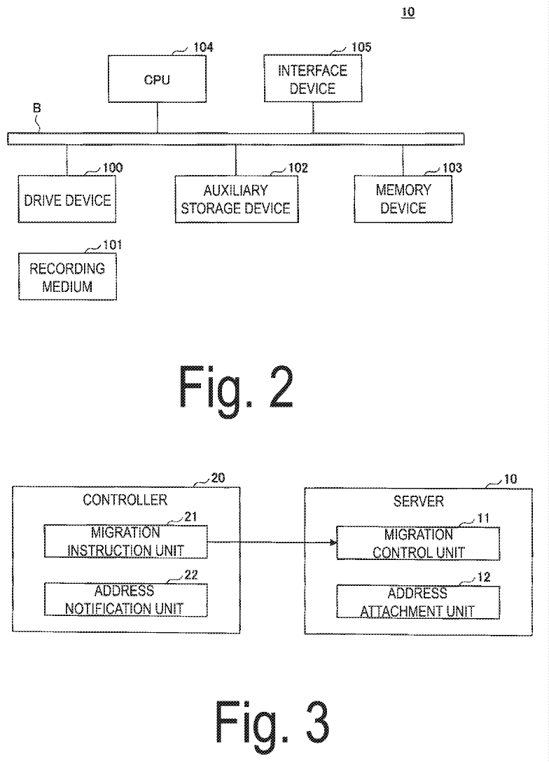

FIG. 3 is a diagram illustrating an example of a functional configuration of the server 10 and the controller 20 in the first embodiment. In FIG. 3, the server 10 includes, for example, a migration control unit 11 and an address attachment unit 12. Each of these units is achieved by processing that one or more programs installed on the server 10 cause the CPU 104 to execute.

The migration control unit 11 controls migration (transfer) to the transfer destination of the VNF that is operated on the server 10 or migration from the transfer source (the other server 10) of the VNF that is operated on the other server 10.

The address attachment unit 12 attaches (imparts) an address assigned to the VNF to a transmission source address field of the packet that is output from the VNF that is operated on the server 10.

On the other hand, the controller 20 includes, for example, a migration instruction unit 21 and an address notification unit 22. Each of these units is achieved by processing that one or more programs installed on the controller 20 cause the CPU of the controller 20 to execute.

The migration instruction unit 21 instructs the server 10, which is a transfer source, to perform the migration of the VNF.

The address notification unit 22 notifies each packet processing device 30 of the address of each VNF so that packets, output from the respective VNFs on the servers 10 that are the transfer source and the transfer destination, are treated similarly by each packet processing device 30.

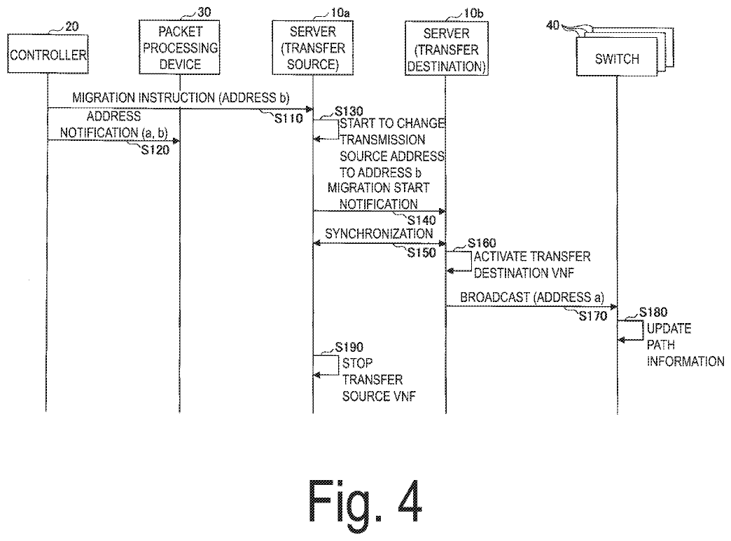

Hereinafter, a processing procedure that is executed in the data transfer system 1 will be described. FIG. 4 is a sequence diagram illustrating an example of a processing procedure regarding migration of the VNF in the first embodiment. In FIG. 4, an example in which the VNF that is operated on the server 10a is migrated (transferred) to the server 10b will be described. That is the server 10a is a transfer source, and the server 10b is a transfer destination of the migration. In description of FIG. 4, “a” is imparted to the end of the reference sign of each unit regarding the server 10a, and “b” is imparted to the end of the reference sign of each unit regarding the server 10b in the functional configuration illustrated in FIG. 3.

For example, the migration instruction unit 21 of the controller 20 transmits, based on an automatic decision, a user instruction, or the like, an instruction to perform the migration of the VNF (hereinafter referred to as a “transfer source VNF”) that is operated on the server 10a to a migration control unit 11a of the server 10a (S10). In this instruction, the server 10 that is a transfer destination is designated. Here, the server 10b is designated as the transfer destination. Further, the instruction also includes “address b” as a new address for the transfer source VNF. The address b is an address that the migration instruction unit 21 of the controller 20 assigns (generates) using a predetermined method at the time of the migration. Any method may be adopted as such a method as long as the method enables assignment of an address that does not overlap with the other addresses used in the network N1 and does not overlap with a current address (before transfer) of the transfer source VNF. A current address of the transfer source VNF is assumed to be “address a”.

Subsequently to step S110 or in parallel with step S110, the address notification unit 22 of the controller 20 notifies the packet processing device 30 that address a and address b are being used by the same VNF (that is, address a and address b are notified) when there is the packet processing device 30 that performs packet control such as filtering using an address of a packet (S120). This is intended to apply processing, which is the same as the processing for a packet in which address a is attached to the transmission source address field, to a packet in which address b is attached to the transmission source address field.

On the other hand, an address attachment unit 12a on the server 10a that has received a migration instruction starts to impart address b rather than address a to the transmission source address field of the packet output from the transfer source VNF (S130). Thus, when each switch 40 receives the packet output from the transfer source VNF, the switch 40 recalculates a path for address b and updates the path information. Here, processing of the packet in the packet processing device 30 becomes similar to processing of the packet in which address a is attached to the transmission source address field due to an effect of step S120.

Subsequently, the migration control unit 11a notifies the migration control unit 11b of the transfer destination server 10b of start of the migration in response to the migration instruction (S140).

Subsequently, data for migration of the transfer source VNF is synchronized between the migration control unit 11a and the migration control unit 11b (S150). In other words, data relevant to the transfer source VNF stored on the server 10a is transferred to the server 10b. When an update of the data regarding the transfer source VNF occurs during synchronization, an updated portion is also transferred to the server 10b. Packet processing in the transfer source VNF continues during the data synchronization. During this time, the address attachment unit 12a imparts address b to the transmission source address field of the packet output from the transfer source VNF.

When the data synchronization is complete and the migration control unit 11b activates the transfer destination VNF on the server 10b (S160), the transfer destination VNF transmits the broadcast packet (S170). In this case, an address attachment unit 12b attaches address a taken over from the transfer source VNF to a transmission source address field of the broadcast packet. Thus, each switch 40 that has received the broadcast packet updates the path information so that a packet addressed to address a reaches the server 10b (S180).

The address attachment unit 12a may start to impart address b to the transmission source address field of the packet output from the transfer source VNF immediately before the transfer destination VNF transmits the broadcast packet. That is, when an address overlapping between the transfer source VNF and the transfer destination VNF can be avoided, a timing at which the address attachment unit 12a starts to impart address b to the transmission source address field of the packet output from the transfer source VNF is not limited to a specific timing.

Thereafter, the migration control unit 11a monitors whether a packet reaches the transfer source VNF. When a situation in which the packet does not reach the transfer source VNF continues for a predetermined time or longer, the migration control unit 11a determines that the update of the path information by each switch 40 has been completed, and stops the transfer source VNF (S190).

As described above, according to the first embodiment, it is possible to avoid the occurrence of a situation in which the address is duplicated between the transfer source VNF and the transfer destination VNF. Thus, when the switch 40 performs the path update using the broadcast packet transmitted by the transfer destination VNF, it is possible to prevent the occurrence of re-update of the path information based on the data packet. As a result, it is possible to enable a packet addressed to address a to reach the transfer destination VNF. That is, it is possible to avoid the occurrence of communication error when software relevant to packet processing is transferred to another computer.

Further, the packet processing device 30 or the like is notified of an address before change (address a) and an address after change (address b), and thus similar processing can be applied to packets having each address as the transmission source (that is, packets output from substantially the same VNF).

Next, a second embodiment will be described. Differences between the second embodiment and the first embodiment will be described. Points not particularly described in the second embodiment may be the same as in the first embodiment.

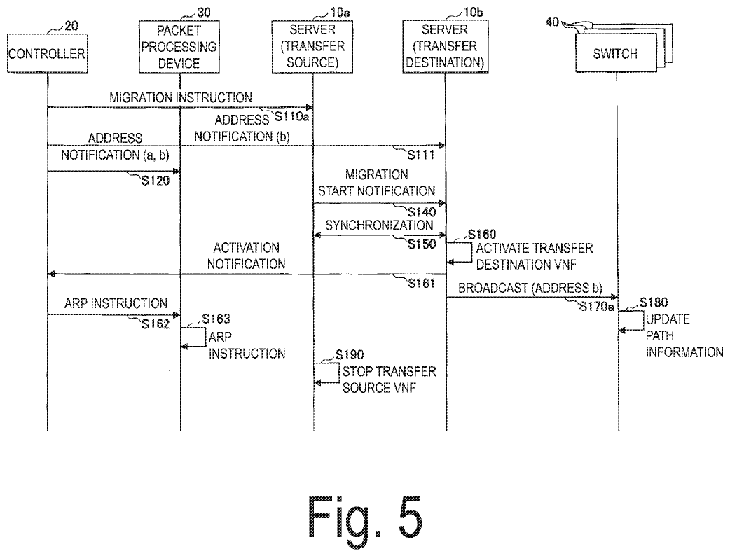

FIG. 5 is a sequence diagram illustrating an example of a processing procedure regarding migration of a VNF in the second embodiment. In FIG. 5, steps that are the same as those in FIG. 4 are denoted by the same step numbers, and descriptions thereof will be omitted.

In FIG. 5, S110a is executed instead of step S110. For a migration instruction in step S110a, address b is not designated. Thus, step S130 of FIG. 4 is not executed in the second embodiment. That is, the transmission source address of the packet output from the transfer source VNF is not changed (remains as address a).

Subsequently to step S10a or in parallel with step S110a, the migration instruction unit 21 of the controller 20 assigns (generates) address b using a predetermined method, sets address b as an address to be assigned to the transfer destination VNF, and notifies the migration control unit 11b of the server 10b of address b. That is, in the second embodiment, overlap of the addresses between the transfer source VNF and the transfer destination VNF is avoided by changing the address of the transfer destination VNF rather than the address of the transfer source VNF.

When the migration control unit 11b activates the transfer destination VNF on the server 10b (S160), the migration control unit 11b notifies the controller 20 of the activation of the transfer destination VNF (S161). In response to the notification, the address notification unit 22 of the controller 20 transmits an instruction to execute an Address Resolution Protocol (ARP) to a device that manages correspondence between an IP address and a MAC address, such as the packet processing device 30 (S162). The IP address and the MAC address (address b) of the transfer destination VNF are included in the execution instruction. The packet processing device 30 that has received the execution instruction, for example, executes the ARP for the IP address (S163). Specifically, the MAC address associated with the IP address is changed to address b.

Further, in FIG. 5, step S170a is executed instead of step S170. In step S170a, the transfer destination VNF transmits a broadcast packet (S170. In this case, the address attachment unit 12b attaches address b notified in step S11 to the transmission source address field of the broadcast packet. Thus, each switch 40 that has received the broadcast packet updates the path information so that a packet addressed to address b reaches the server 10b (S180).

According to the second embodiment, it is possible to obtain the same effects as those of the first embodiment, as described above.

In each embodiment, a migration procedure of the VNF is merely an example. Further, the embodiment may also be applied to transfer of software other than the VNF as long as the software performs packet processing.

In each embodiment the migration control unit 11 is an example of a control unit. The address attachment unit 12 is an example of an attachment unit. The server 10 is an example of an information processing device. The controller 20 is an example of a control device and a notification unit. The address notification unit 22 is an example of a notification unit.

While the embodiments of the present invention have been described above, the present invention is not limited to specific embodiments and can be subjected to various modifications and changes within the scope of the gist of the present invention defined in the claims.

### REFERENCE SIGNS LIST

10 Server
11 Migration control unit
12 Address attachment unit
20 Controller
21 Migration instruction unit
22 Address notification unit
30 Packet processing device
40 Switch
100 Drive device
101 Recording medium
102 Auxiliary storage device
103 Memory device
104 CPU
105 Interface device
B Bus

1. An information processing device comprising:
a control unit, including one or more processors, configured to control a transfer of software performing processing of a packet to or from another computer; and
an attachment unit, including one or more processors, configured to attach, to a packet output from the software of a transfer source or a transfer destination, a transmission source address different from the transfer destination or the transfer source.

2. The information processing device according to claim 1, wherein the attachment unit sets an address notified by the other computer as the transmission source address.

3. A control device instructing the information processing device according to claim 1 to perform the transfer, the control device comprising:
a notification unit, including one or more processors, configured to notify a device processing a packet output from the software of an address of the transfer source and the transfer destination.

4. A transfer method comprising:
controlling, by a computer, a transfer of software performing processing of a packet to or from another computer; and
attaching, by the computer, to a packet output from the software of a transfer source or a transfer destination, a transmission source address different from the transfer destination or the transfer source.

5. The transfer method according to claim 4, further comprising:
notifying, by a control device instructing the computer to perform the transfer, a device processing a packet output from the software of an address of the transfer source and the transfer destination.

6. A non-transitory computer readable medium storing one or more instructions causing a computer to execute:
controlling a transfer of software performing processing of a packet to or from another computer; and
attaching, to a packet output from the software of a transfer source or a transfer destination, a transmission source address different from the transfer destination or the transfer source.

7. The non-transitory computer readable medium according to claim 6, wherein the one or more instructions further comprises:
causing a control device, instructing an information processing device to perform the transfer, to execute notifying a device processing a packet output from the software of an address of the transfer source or the transfer destination.
